(19) United States
(12) Patent Application Publication
(10) Pub. No.: US 2018/0122190 A1
(43) Pub. Date: May 3, 2018

(54) SPORT-THEMED CASINO GAME

(71) Applicant: HMD Entertainment, LLC, Rochester, NY (US)

(72) Inventor: Ronald J. Wolff, Rochester, NY (US)

(73) Assignee: HMD Entertainment, LLC, Rochester, NY (US)

(21) Appl. No.: 15/796,761

(22) Filed: Oct. 28, 2017

Related U.S. Application Data
(60) Provisional application No. 62/414,353, filed on Oct. 28, 2016.

(51) Int. Cl. G07F 17/32

(52) U.S. Cl. CPC G07F 17/3272; G07F 17/3288; G07F 17/3293; G07F 17/322

(57) ABSTRACT

Disclosed herein are a casino game as well as the methods and apparatus for conducting the game. In one embodiment, the sport-themed game includes a game table or surface (physical or virtual) on which wagering and steps of the game are carried out using playing cards to implement the game as a Black Jack or Casino War type game with Craps-like side betting.

This application claims priority under 35 U.S.C. § 119(e) from U.S. Provisional Patent Application No. 62/414,353 for FIELD GOAL GAME, filed by Ronald J. Wolff on Oct. 28, 2016, which is hereby incorporated by reference in its entirety.

Disclosed herein are a casino game as well as the methods and apparatus for conducting the game. In one embodiment, the Field Goal™ or Slap-Shot™ games are sport-themed casino games that include a game table or surface (physical or virtual) on which wagering and steps of the game are carried out using playing cards, at least in part, to implement the game.

### BACKGROUND AND SUMMARY

The following disclosure is directed to a sport-themed casino game, for example entitled Field Goal™ or Slap-Shot™, which incorporates aspects of popular casino games. The disclosed game, including various embodiments and alternatives, provides an enjoyable experience for the Blackjack and/or Casino War player due to its speed of play, and the Craps player due to its side betting option. The game is designed to be fair to both the player and the casino or house. It is simplistic in design which allows the casual observer to easily understand the flow of the game and join in the fun.

The game, which may be implemented in a physical form or using a virtual or video gaming system, provides for betting on one dealer card and multiple player cards received with an individual wager that must be made at the start, and is enabled using a Blackjack-type table or board on a table-top or similar horizontal playing surface. All players place ante wagers. If the first card the dealer receives, referred to as a “Post”, is the Ace of Diamonds, all players automatically win. Otherwise they are wagering that subsequent cards, dealt to each active player determined by rotation around the table from the dealer's left, called “Kicks”, will be the Ace of Diamonds or equal to or within 5 (five) face value units of the face value of the “Post” in one direction only; if a choice being possible having been determined by the player before the “Kick” is dealt, where Jacks are worth 11, Queens are worth 12, Kings are worth 13, and Aces are worth either 1 or 14. A “Goalpost” structure or equivalent markers would be employed on the game board to show the respective face value of each of the Posts.

The game does not require the player to best the dealer or another player to win. Players watch the dealer deal his “Post” card (121), and then play the Field Goal game individually from the dealer's left to right. If the Dealer deals his or herself an Ace of Diamonds as the “Post” card, every player is an automatic winner at even money (131). Any Ace of Diamonds dealt as a “Kick” card to an individual player is an automatic winner for that player at even money. If the “Kick” card exactly matches the dealer's “Post” card (i.e. 3 of Clubs “Post” card, 3 of Clubs “Kick” card), the player is paid at 3 to 2 odds. At any time before a “Kick” card is dealt, any non-active player who placed an ante at the table can side wager on whether or not the “Kick” will be “Good” or “Wide”. A “Referee” marker is also placed on a set space beyond the “Goalposts”, and is used to adjust the inherent advantage that “Wide” bettors would normally have. Players can also wager on whether the “Kick” will “Hit the Goalpost” by having the same value as one of the two Goalpost spots. At the start of the player's first “Kick” in a round, all players can side wager on if the active player will get a run of three consecutive winning kicks or a run of six consecutive winning kicks. The game may be played with an eight deck shoe and an electromechanical continuous shuffling device, similar to Blackjack.

Disclosed in embodiments herein, and generally depicted in FIGS. 2A-2B, is a method of playing a casino game, comprising: (a) providing one or more “decks” (physical or virtual) of 52 playing cards; (b) providing an area in which wagers may be placed by participants in a blackjack-type fashion, wherein the area includes (1) a location for the dealer to receive his face up card; (2) an area at each player station to wager that the dealer's card will be the Ace of Diamonds or that the players subsequent card or cards will be the Ace of Diamonds or of a face value either equal to the dealer's “Post” card or within five of it in one direction; (3) an area at each player station to wager on whether or not the active player will be successful in winning or unsuccessful; (4) an area at each player station to wager that each active player's card dealt will be equal in face value to either of the two value spots covered by each “Goalpost”; (5) an area at each player station to wager before the active player's first card is dealt that the player will be successful three times in a row; (6) an area at each player station to wager before the active player's first card is dealt that the player will be successful six times in a row; (7) a graphic with small areas representing the value of the cards from Ace through all the values and back to Ace, in a linear layout if front of the dealer; (8) a set of “Goalposts”, consisting of two uprights and a crossbar in any material, for the dealer to mark where each players' “Kick” subsequent card or cards has to fall between; (9) a “Referee” marker in any material for the dealer to mark outside or beyond the position of the “Goalposts” where side wagering that the active player will be unsuccessful (i.e., will not win); (10) a graphic to describe the payout for a dealer Ace of Diamonds in front of the dealer; (11) a graphic to describe the payout for a player Ace of Diamonds in front of the dealer; (12) a graphic to describe the payout for the player exactly matching the dealer card in a semicircle in front of the dealer; (13) a graphic to describe how the “Referee” marker affects the outcomes for “Wide” side bettors in a concentric semicircle in front of the dealer; (c) the game being played by the following steps, (1) the player(s) commence ante wagering; (2) a dealer manually or mechanically dispenses a face up card to himself; (3) if he/she is dealt the Ace of Diamonds, all players having automatically won the hand (131) and paid even money on their wager; (4) the dealer playing the game with each individual player one at a time from their left to right; (5) if the numeric face value of the dealer's “Post” card is a 6 through a 9, or Ace other than of the Diamond suit (132), the player chooses to go “High” or “Low” for which direction of 5 from the “Post” card the face value of the next revealed card dealt to him will be; (6) the dealer marks the “Goalposts” on the layout appropriately and marks the “Referee” at one spot ahead of the highest goalpost (141), unless the highest spot is the high Ace in which the “Referee” would be placed on the 8 spot; (7) non-active players may now make their “Good” and “Wide” side bets (151) and all players can side bet on the player making a run of three consecutive wins, six consecutive wins, and/or “Hit the Goalpost”; (8) the dealer places a face up card to the player at their station (162); (8) if the card is the “Ace of Diamonds, the player and all “Good” and “Wide” side bettors automatically win at a 1 to 1 payout (174); (9) if the value of the card is equal to or within five of the direction directed by the value of the “Post card”, or determined by the player if given the choice, the player and all “Good” side bettors win (173) and is paid even money on their wagers unless the card exactly matches the dealer card in which case they are paid at 3 to 2 (183); (10) if the player loses (171 or 172), the “Wide” side bettors are paid at even money (171) unless the card is equal to where the “Referee” marker is (172), in which case if the card was a Spade, Club, or Heart, the “Wide” bettors push (tie) (181), and if it is a Diamond they lose (182); (11) if the player's card has the same face value as one of the two Goalposts, all “Hit the Goalpost” wagers win and are paid, for example, at 5-1; (12) if the player wins (184), he can let his winnings ride, add or subtract to his “Ante” space and request another “Kick” card and returning to step (5) until he loses or passes to the next player; (10) if the player loses at any point of his turn, the dealer is finished with that player and moves to the next player (161); (13) if the player wins three or more “Kicks”, the next player has the option of requesting a new dealer up card to move the “Goalposts” (191), but does not get the automatic Ace of Diamonds win that comes with the initial dealer up card; (14) if the player wins three “Kicks” then all players wagering on a “Run of 3” successful kicks are paid at 5-1 (or 6-1 in an alternate version); (15) if the player wins six “Kicks” then all players wagering on a “Run of 6” successful kicks are paid at 25-1 (or 18-1 in an alternative version) (see e.g., 1202,1203,1302); (16) if all players have had their opportunity to play, a new round commences (1101) at step (1); (17) in a single deck game, the cards are shuffled after each round; (18) in a manual multideck game, if the shoe reaches the cut card, when the round is over the cards are shuffled and play recommences at step (1); and (19) in an electromechanical continuous shuffle multi-deck game, a player's kick cards are removed from the layout and replaced in the machine before the next player.

Further disclosed in embodiments herein is the casino game as disclosed, wherein the wagering area and card presentation area are displayed on a video display, and where wagers are placed by players via a user interface such that the wagers are depicted on said display. More specifically, a method of conducting a wagering game on a video gaming system including a processor, a video display and player input controls, comprises: (a) a processor acting as a dealer providing at least one virtual deck of playing cards; (b) providing a wagering and card play area in which Black Jack-type wagers may be placed by participants, wherein the area includes individual player stations in order for the player to make the wagers of the game as well as an area to receive cards from the dealer; (c) a dealer area to receive a dealer up card; (d) another semicircular area with spots labeled “A”, “2”, “3”, “4”, “5”, “6”, “7”, “8”, “9”, “10”, “J”, “Q”, “K”, and “A”, for the dealer to mark at least two “Goalposts” to indicate the 6 (six) consecutive card values players must hit with their dealt cards, and a “Referee” marker to provide a house advantage for “Wide” side bettors; (e) the game being played by the following steps: (1) at least one player makes a wager by indicating the wager on a wagering space in front of the player's station; (2) the dealer distributing an up card the dealer, the up card indicated in the dealer's station; (3) the processor examining the respective dealer and player's hands and paying even money for a win automatically if the player's card is the Ace of Diamonds; (4) the processor otherwise requesting input from players to determine if they wish to go “High” or “Low” during their turn if the dealer up card is a 6, 7, 8, 9, or Ace of a suit other than Diamonds; (5) the processor, acting as the dealer, marks card face values on the game layout with the “Goalposts” and the “Referee” marker, wherein the Goalposts identify a range of cards; (6) the processor allowing non-active players to place a side wager on whether or not the active player will be successful or unsuccessful after the active player receives another card from the dealer; (7) the processor further allowing for a player to engage in a possible side wager that at least one of the following will occur (i) any card dealt to a player will have the same face value as the card face values covered by a Goalpost, or (ii) that a player will have a three or six consecutive win run, (8) the processor, acting as the dealer; distributing a face up card to each player, one player at a time; (9) the processor, acting as the dealer, settling an active player's wager as well as all “Good” side bettors by removing losing wagers and paying those players and side bettors that were dealt a card the same as one of the six consecutive covered face values (e.g., with Aces equal to 1 or 14, Jacks=11, Queens=12, and Kings=13), as well as all “Wide” side bettors; (10) the processor, acting as the dealer, then giving a winning player the right to continue playing by adjusting the winning player's “Ante”, having new side bets wagered on him/her and requesting another card from the dealer; (11) the processor, acting as the dealer, then giving the winning player the option to continue playing until losing or passing play to a next player; (12) should a player win three or more consecutive times during a turn, the next player has the option of having the processor, acting as the dealer, deal a new up card to switch the winning subsequent player cards, provided that players do not receive the dealer Ace of Diamonds automatic win for those or any subsequent dealer cards during a round; (13) the processor resolving any side wagers; (14) the processor, acting as the dealer, clearing that player's cards from the virtual table display, moving to the next player and returning to step (4); and (15) when all players have been given a turn, the processor, acting as the dealer, removes the dealer's card and the round ends.

Also disclosed herein is a casino game “board” comprising a wagering area in which wagers may be placed by a participant(s) in a blackjack-type fashion, wherein said wagering area includes: (1) Seven separate player stations where each of between 1 to 7 players receives cards face up; (2) an area at each player station for player wagering on whether or not the dealer's face up card dealt will be the Ace of Diamonds; (3) an area at each player station for player wagering on whether or not his/her face up cards dealt will be the Ace of Diamonds; (4) an area at each player station for player wagering on whether or not his/her face up cards dealt will be equal to or within 5 of the value of the first face card in one direction, higher or lower (5) an area at each player station for non-active players to bet that the active player will win; (6) an area at each player station for non-active players to bet that the active player will lose; (7) an area at each player station for all players to wager if the next player face up card will have the same face value as either of the spots directly covered by the two Goalposts; (8) an area at each player station for all players to wager that on the commencement of the active player's turn he will achieve three consecutive wins without a loss; and (9) an area at each player station for all players to wager that on the commencement of the active player's turn he will achieve six consecutive wins without a loss.

The disclosed game embodiments have odds for the settlement of each winning wager that have been researched and tested with trials using computer methodology and expert professional statistical analysis. These odds, and possible payouts, will be discussed in the detailed description of the game. This is not to suggest that the game is totally dependent on the stated odds and that changing the odds and payouts will fundamentally alter the game or create a new type of game. It is quite possible that a casino or state gaming commission may wish to alter the odds and/or payouts for the benefit of either the players or the casino establishment.

### BRIEF DESCRIPTION OF THE DRAWINGS

FIG. 1A is an illustration of the game board layout in accordance with one embodiment of the Field Goal game, and FIG. 1B is an illustration of the game board layout in accordance with an alternative embodiment referred to as the Slap Shot game;

FIGS. 2A-2B depict a flow chart generally illustrating the order and operations of the game play per round; and

FIGS. 3-4 are illustrations of alternative virtual embodiments for video and on-line implementations of the disclosed game.

The various embodiments described herein are not intended to limit the disclosure to those embodiments described. On the contrary, the intent is to cover all alternatives, modifications, and equivalents as may be included within the spirit and scope of the various embodiments and equivalents set forth. For a general understanding, reference is made to the drawings. In the drawings, like references have been used throughout to designate identical or similar elements. It is also noted that the drawings may not have been drawn to scale and that certain regions may have been purposely drawn disproportionately so that the features and aspects could be properly depicted.

### DETAILED DESCRIPTION

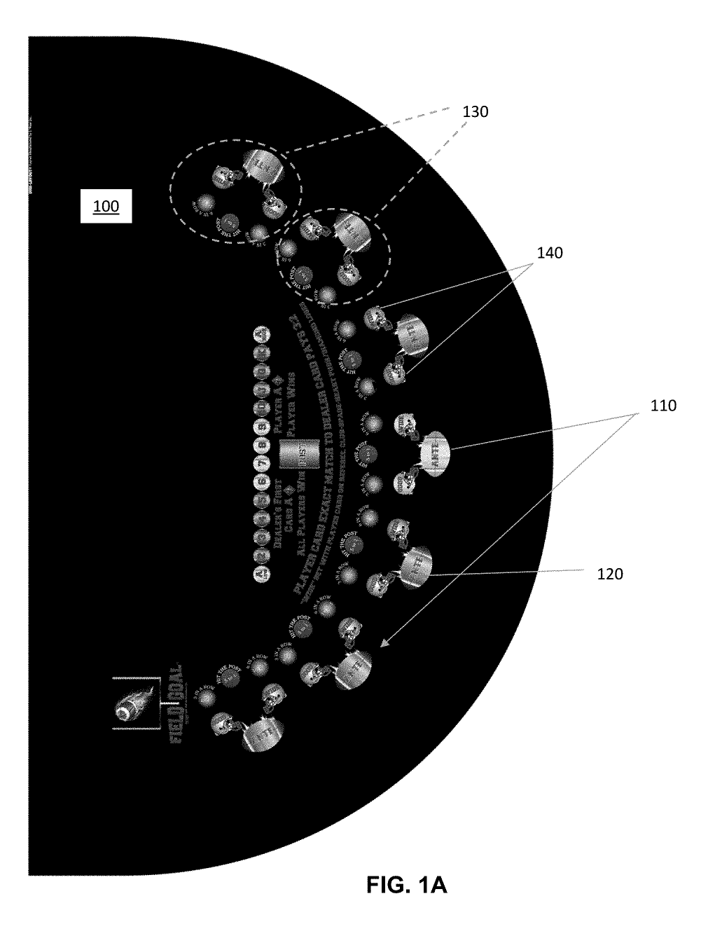

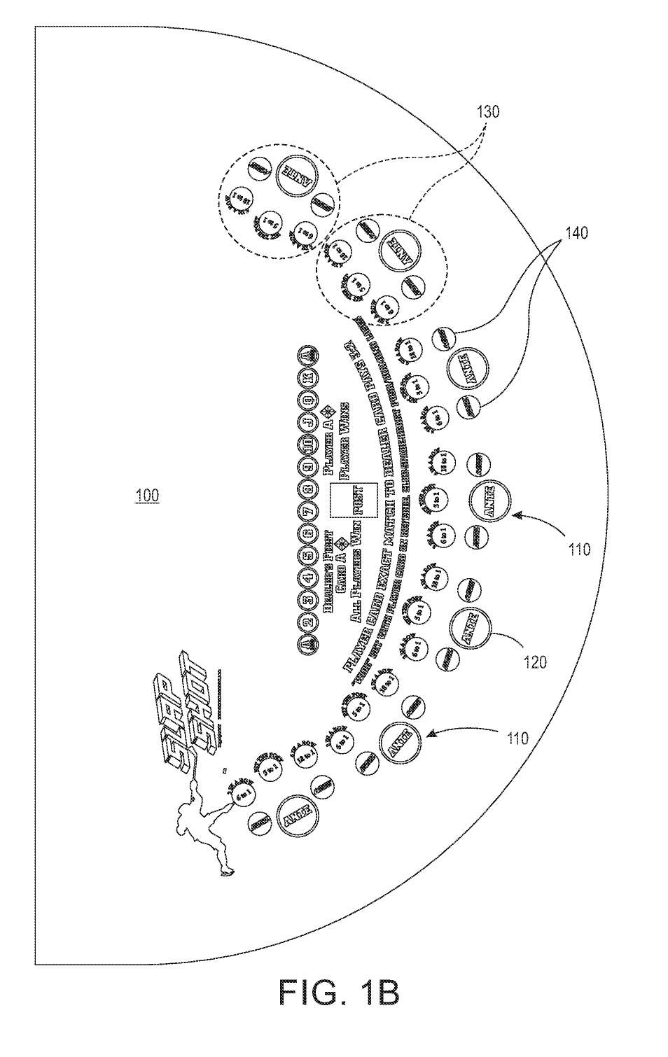

With regard to the disclosed game board layouts, it will be appreciated that although the terminology and graphics may differ, the operative features of the game boards 100 of FIGS. 1A and 1B are similar in nature. Accordingly, although the game operation is described in detail relative to FIG. 1A, the operations are equally applicable to the game board illustrated in FIG. 1B. Referring initially to FIG. 1A, depicted therein is an exemplary game board layout 100 for Field Goal. Although described relative to FIG. 1A as an example, it should be appreciated that various layouts and modifications may be employed to facilitate the playing of the game in either a physical or virtual (i.e. computer-based) manner, and that all such layouts and modifications are intended to be included within the scope of this description. Moreover, as a sport-themed game, the disclosed embodiment is directed to an “American Football” embodiment although alternative sport themes (e.g., soccer, hockey (see e.g., FIG. 1B), basketball, baseball, darts, rugby, cricket etc.) may also be used as themes without significantly deviating from the disclosed methods. For purposes of illustration, certain face cards are represented in game boards and the like, or in the figures and description herein, using capital letters “A” for Ace, “J” for Jack, “Q” for Queen and “K” for King. The suits may be represented in small or large letters by “s” for Spades, “h” for Hearts. “c” for Clubs and “d” for Diamonds, and this may be done on a physical table or board, or on a virtual (video) interface.

Providing an area 110 in which wagers may be placed by participants in a blackjack-type fashion may be done on a physical table or board, or on a virtual (video) interface. A wagering area includes a location at each player station 130 with areas 120 to make wagers and 140 to make side wagers; (1) a wager whether or not the dealer's card will be the Ace of Diamonds; (2) that same wager representing whether or not any of the player's face cards will be the Ace of Diamonds; (3) that same wager representing whether or not the player's cards will be exactly match, be equal to the dealer's card in value, or up to five units in value either higher or lower than the dealer's card. (4) a wager on whether the next card dealt to a player will have the same face card value as either of the two spots directly covered by the Goalposts. (5) a wager on whether before commencement of a player's turn that they will have three consecutive wins without a loss. (6) a wager on whether before commencement of a player's turn that they will have six consecutive wins without a loss.

Although described herein in the embodiment of a casino game played on a game table, it will be appreciated that various aspects of the disclosed game may be similarly presented in an electronic game format. For example, the game may be played on a video gaming system, stand-alone or on-line, where one or more users may place wagers and perform the actions of a player (i.e., virtual player) and where the computer (local or a server-based system) performs the operations of the dealer or the “house” relative to analyzing wagers and payout out winnings. In a video gaming environment, playing of the game is contemplated wherein users may be represented by personalized avatars or similar iconic characterizations. Thus, the game may be played in a computer-simulated version (where actions of other players are simulated) or as a multi-player game where other users are similarly “on-line” and playing around the same game surface. It should be further understood that an on-line version of the disclosed game may be displayed as a simple table-top displaying wagers and cards as dealt (e.g., a top-down view of a representative playing surface), or the game may be animated and/or three-dimensional so that the actions of the players and dealers are realistically simulated (e.g., placing of wagers, dealing and revealing cards, etc.) to provide an experience as though a user were physically present and playing at a casino.

More specifically, the method of conducting the wagering game on a video gaming system, including a processor, a video display and player input controls, comprises the operations of: (a) a processor acting as a dealer providing at least one virtual deck of playing cards; (b) providing a wagering and card play area in which Black Jack-type wagers may be placed by participants, wherein the area includes individual player stations in order for the player to make the wagers of the game as well as an area to receive cards from the dealer; (c) a dealer area to receive a dealer up card; (d) another semicircular area with spots labeled “A”, “2”, “3”, “4”, “5”, “6”, “7”, “8”, “9”, “10”, “J”, “Q”, “K”, and “A”, for the dealer to mark at least two “Goalposts” to indicate the 6 (six) consecutive card values players must hit with their dealt cards, and a “Referee” marker to provide a house advantage for “Wide” side bettors. The game then being played by the following steps: (1) at least one player makes a wager by indicating the wager on a wagering space in front of the player's station; (2) the processor, again acting as the dealer, distributing an up card to the dealer, the up card indicated in the dealer's station; (3) the processor examining the respective dealer and player's hands and paying even money for a win automatically if the player's card is the Ace of Diamonds; (4) the processor otherwise requesting input from players to determine if they wish to go “High” or “Low” during their turn if the dealer up card is a 6, 7, 8, 9, or Ace of a suit other than Diamonds; (5) the processor, acting as the dealer, marks card face values on the game layout with the “Goalposts” and the “Referee” marker, wherein the Goalposts identify a range of cards the Goalposts on respective layout spots to cover the range of card values selected based upon (i) the dealer card alone, or (ii) the dealer card in conjunction with the active player's choice of direction, and the Referee marker is placed by the processor, acting as the dealer, at one spot higher than the highest Goalpost, unless the high Goalpost is the high Ace, in which case the Referee marker is then set to the “8” spot on the layout; (6) the processor allowing non-active players to place a side wager on whether or not the active player will be successful or unsuccessful after the active player receives another card from the dealer; (7) the processor further allowing for a player to engage in a possible side wager that at least one of the following will occur,

(i) any card dealt to a player will have the same face value as the card face values covered by a Goalpost, or

(ii) that a player will have a three or six consecutive win run;

(8) the processor, acting as the dealer, distributing a face up card to each player, one player at a time; (9) the processor, acting as the dealer, settling an active player's wager as well as all “Good” side bettors by removing losing wagers and paying those players and side bettors that were dealt a card the same as one of the six consecutive covered face values (e.g., with Aces equal to 1 or 14, Jacks=11, Queens=12, and Kings=13, as well as all “Wide” side bettors); (10) the processor, acting as the dealer, then giving a winning player the right to continue playing by adjusting the winning player's “Ante”, having new side bets wagered on him/her and requesting another card from the dealer; (11) the processor, acting as the dealer, then giving the winning player the option to continue playing until losing or passing play to a next player; (12) should a player win three or more consecutive times during a turn, the next player has the option of having the processor, acting as the dealer, deal a new up card to switch the winning subsequent player cards, provided that players do not receive the dealer Ace of Diamonds automatic win for those or any subsequent dealer cards during a round; (13) the processor resolving any side wagers; (14) the processor, acting as the dealer, clearing that player's cards from the virtual table display, moving to the next player and returning to step (4); and (15) when all players have been given a turn, the processor, acting as the dealer, removes the dealer's card and the round ends. Furthermore, the side wagers mentioned above include a side wager selected from the group consisting of a “3 Win Run,” and a “6 Win Run”.

Similarly, although characterized using conventional casino components such as chips of different value, it will be appreciated that aspects of the disclosed Field Goal game may be carried out using a digital or similar gaming table whereby at least the table surface is implemented using a large format display device, and wagers are placed by users using some form of interactive interface. As an example, similar to games provided by companies such as BingoTimes™ (www.bingotimes.com.tw/english/index.html), a user may have a digital representation of chips on a “stack” in front of them, and even a game board, and the user could select and drag a chip icon(s) from the player's stack to one of the wagering locations identified herein, in the same manner that an icon can be dragged and dropped on a conventional user interface, in order to place a wager. Likewise, in the event of a wager that pays off, the user's stack would be credited and receive additional chips upon payout.

Although it will be appreciated that wagers may be represented in monetary units where appropriate or legal, non-monetary units may be employed in such games as well. Although the Field Goal game is described herein in considerable detail with reference to certain versions thereof, other versions are possible. As noted above, for example, the gaming method described is not limited to being played as a table game. The game may be played as a board game or by using computers or electronic devices having audio and video outputs. Thus, the term “card” as used in this application refers to traditional playing cards made of paper stock having game indicia, such as numbers (2-10), suits (Diamonds, Hearts, Spades, and Clubs), and characters (Aces, Jacks, Queens, and Kings), but the term is also used to refer to one of a plurality of electronic images of traditional cards. The term “dealer” may be an actual person distributing the cards. It is noted that the dealer may also be a player, and the dealer does not have to be associated with a business entity having a stake in any profits derived from operating the game (e.g., the “house”). The term “dealer” may also be used to refer to a virtual dealer that is programmed through an electronic device or computer. And, the function of the dealer may also be performed, or at least assisted, by any of a number of gaming-based devices including automated card shuffling devices as well as robotic arms suitable for shuffling, dealing, revealing cards, removing wagers, etc. One example of such a device is available from Bingo Times Digital Technology Co. Ltd of Taiwan (e.g., Model R200 offers a complete Baccarat set up with an automated arm for the Banker).

The game disclosed herein can be readily implemented in a wide variety of additional forms and media including, but not limited to: single player slot video machines, multi-player slot video machines, electronic games and devices, lottery terminals, software, as well as home, and Internet entertainment. Furthermore, the game can be readily implemented in software, which can be downloaded or stored on a disk (e.g., magnetic disk, compact disc (CD), USB memory stick, etc.,) and used with a computer system. In one embodiment, the gaming method disclosed may be implemented as a computer game which may be executed via disk or downloaded from the Internet and played using a computer, gaming console, or an electronic handheld device (e.g., personal digital assistants (PDA), smart phones, etc.). Such embodiments may be played individually or may be played with other players. In another embodiment, the disclosed game may be played as an interactive online gambling game wherein the player may play against the “casino” or “bank” individually or with other players via the Internet. The dealer may be an actual person or a virtual dealer. Similarly, the other players may be actual people or they may be computer generated simulations of virtual players. In yet other embodiments of the disclosed game, the gaming method may be played against a casino or wagering establishment from a remote location via the Internet.

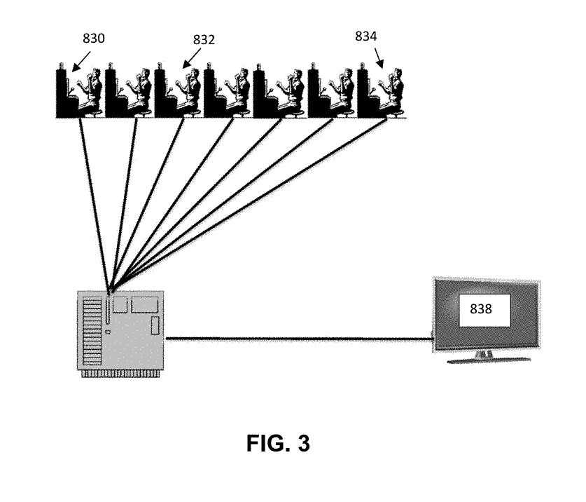

Certain gamblers feel uncomfortable with the fast pace and frenetic activity which often accompanies multiple players around a table game such as Blackjack, Casino War, or Craps. There are electronic formats found in the casino environment that provide differing levels of privacy for the player. FIG. 3, for example, depicts multiple players 830, 832 and 834 (seven are displayed although the number could vary) using an electronic video touch screen format to place wagers for what otherwise would be a regular table format with a dealer revealing cards, marking spaces on the game board, and inputting the revealed cards to a console. A Computer Central Processing Unit (CPU) or individual processors in each player's video terminal could settle wagers and tally present account totals. FIG. 3 depicts a scenario, however, of multiple players (830, 832, 834) with individual touch screen terminals having their wagers centrally processed for computer graphic display on an individual's display or on a large wall monitor 838. Also contemplated is the possibility of a user or player having a private game on his/her touch screen terminal without multiplayer interaction. All of the above-mentioned scenarios have been experienced for game play at various casinos. Accordingly, it is not to be construed that only certain input device types, processing device types, or display device types could be used with the disclosed embodiments. Rather, the present disclosure contemplates the use of currently available as well as future electronic, mechanical and/or electromechanical devices and systems that may be employed to carry out one or more features and operations of the game as disclosed herein.

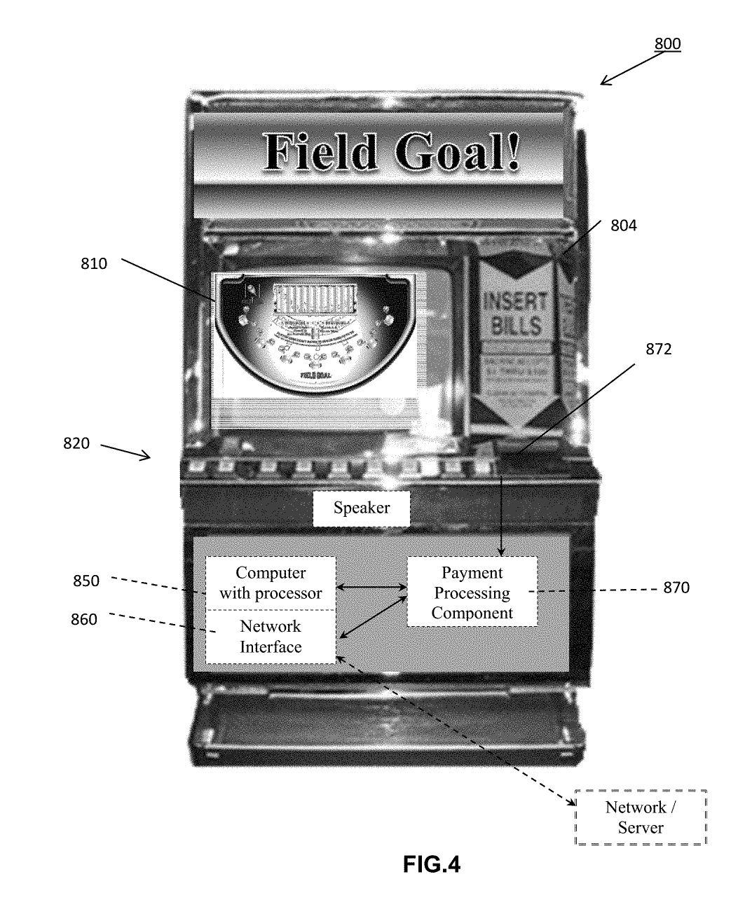

FIG. 3 is also intended to depict the scenario of players using individual computing devices for Internet or other networked game play. Instead of wagering being displayed on a central screen, it would be fed back to each individual computer through the main website server. It is also quite possible the game could be played by individuals with downloaded software that would not involve internet interaction. FIG. 4 is an illustration of just such an embodiment, where the user is essentially playing on and against only the computer (or possibly other simulated players), and the computer carries out the functions of the dealer or house. Referring to FIG. 4, where such an embodiment is illustrated, the processor or computer-driven gaming system 800 includes a housing or shell 804 in which various features are installed, including a gaming interface comprising both a video screen display 810 (CRT, LED, LCD, touch-screen, etc.), as well as a series of player input controls such as buttons 820 (e.g., physical buttons, touch-screen buttons, or joystick or mouse-type interface) and similar interface elements through which the user interacts with the system to control the user's input actions. As one example, for placing wagers the user could select and drag a chip icon(s) from the player's stack 812 to one of the wagering locations identified herein (114), in the same manner that an icon can be dragged and dropped on a conventional user interface, in order to place a wager. As illustrated, the video interface includes a depiction of a game board or playing surface (e.g., FIGS. 1A and 1B), but may also provide different screens, windows and the like to enable user interaction, game demonstration, account login/verification, single or multi-player gaming options, and the like. Likewise, in the event of a wager that pays off, the user's stack would be credited and receive additional chips upon payout. Also included in system 800 is a computer 850, a network interface 860 connecting the system to an intranet or the Internet via a wired or wireless connection, and thereby allowing a user to play against the house or other players that are at similar gaming terminals or on-line. As illustrated, such a system may be implemented via a client-server or similar architecture so as to enable one or more remote systems 800. The system further includes a payment processing component 870. In one embodiment the payment processing component 870 may be connected to a conventional coin or paper currency receiver 872 as illustrated in the embodiment of FIG. 4. In alternative embodiments, the payment receiving component may include a credit card swipe/scanner or various on-line payment mechanisms, facilitated via the network, where a user is presented with a video display prompting the user to log in to a gaming account, etc., and which may further provide a visual indication of the user's credits. In all scenarios, the payment processing component is suitable for arranging and authenticating the availability and/or transfer of funds from a user account in order to make such funds available for wagering via the system. Similarly, the crediting of funds is handled by the payment processing component 870 upon the user leaving or logging off from system 800.

Also contemplated is a portable cellular or smart phone device being used with a downloaded application to play the game. Since the game board size may create visual issues on small screens, a “zoom in” ability is depicted in a region, where the board could be scrolled or panned (e.g., using known gestures, navigational buttons or techniques) for betting or game play purposes. Only parts of the board would likely be on display at one time with this type of device, but this is not to suggest that the game would be fundamentally changed with any board depiction which deviates from the described board, even though there may be modifications in order to permit a more user-friendly video display. Nor should it be construed that the screen size of the portable device is a factor requiring fundamental change. Nonetheless, the layout or format of the game board may be modified in order to permit ease of use or wagering via hand-held or other portable devices.

The game can also be played in home table form for private party purposes. It can be marketed and used as any other board game with or without electronic components. For example, an electronic card shuffler, packet dealer, and card revealer could be envisioned for an otherwise manual board game. A designated dealer can manually do these tasks as well, which is the manner in which the board depicted in FIG. 1A is described relative to one embodiment.

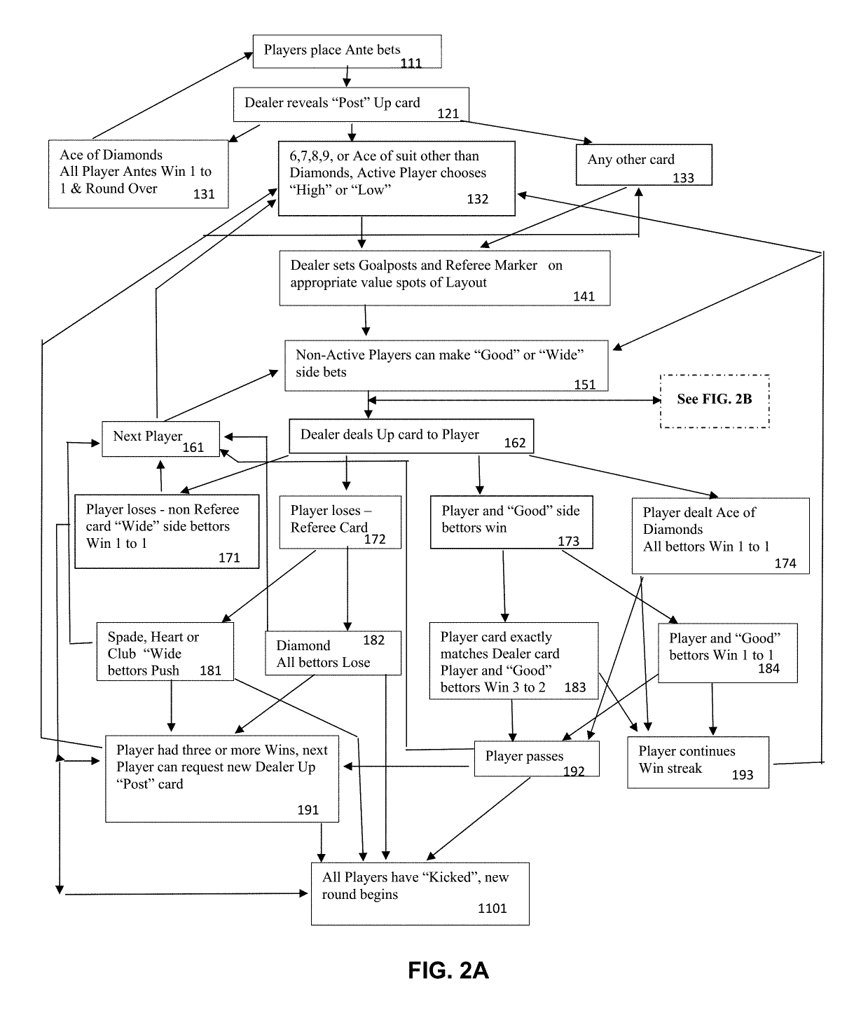

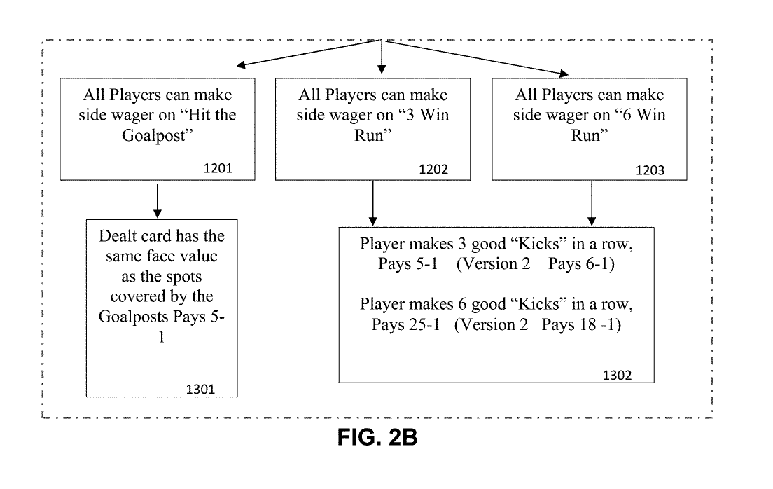

Having described the general layout of the playing board or surface, as well as several virtual game embodiments and with the various bets that can be played thereon, attention is next turned to the manner of playing an exemplary game. Referring also to FIGS. 2A-2B, the game may be played by the following steps as general depicted in the flowchart. First, the player(s) commence “Ante” wagering (111) at their particular station in locations around the player side of the table. They each place a wager at a designated space at their respective stations. Next the dealer takes a freshly shuffled deck by either manual or mechanical means or multiple decks shuffled and placed in a manual, mechanical card dispensing shoe or electromechanical automatic continuous shuffler and dispenses a face up card to himself. He/she then settles all players' wagers. The method illustrated in FIGS. 2A-2B includes: (a) providing one or more “decks” (physical or virtual) of 52 playing cards; (b) providing an area in which wagers may be placed by participants in a blackjack-type fashion, (c) the game being played by the following steps, (1) after the player(s) commence ante wagering (111); (2) a dealer, or processor acting as a dealer, manually or mechanically dispenses a face up card to the dealer's position; (3) if the dealer is dealt the Ace of Diamonds, all players have automatically won the hand (131) and are paid even money on their wager; (4) if there is no automatic win, the dealer commences playing the game with each individual player one at a time from their left to right; (5) if the numeric face value of the dealer's “Post” card is a 6 through a 9, or Ace other than of the Diamond suit (132), the player chooses to go “High” or “Low” for which direction of five positions from the “Post” card the face value of the next revealed card dealt to him will be; (6) the dealer marks the “Goalposts” on the layout appropriately and marks the “Referee” at one spot ahead of the highest goalpost (141), unless the highest spot is the high Ace in which the “Referee” would be placed on the 8 spot; (7) non-active players may now make their “Good” and “Wide” side bets (151); (8) all players may now side wager that the next card revealed to the active player will “Hit the Goalpost” and have the same value as either Goalpost covered spot. During the game, if the player's card has the same face value as one of the two Goalposts, all “Hit the Goalpost” wagers win and are paid, for example, at 5-1, as represented in operations 1201 and 1301 in FIG. 2B. (9) all players may wager that the active player will be successful on three consecutive “Kicks”; (10) all players may wager that the active player will be successful on six consecutive “Kicks”, and if the player wins three “Kicks” then all players wagering on a “Run of 3” successful kicks are paid at 5-1 (or 6-1 in an alternate version) and if the player wins six “Kicks” then all players wagering on a “Run of 6” successful kicks are paid at 25-1 (or 18-1 in an alternative version), as represented by the various options at 1202, 1203, and 1302; (11) the dealer places a face up card to the player at their station (162); (12) if the card is the “Ace of Diamonds, the player and all “Good” and “Wide” side bettors automatically win at a 1 to 1 payout (174); (13) if the value of the card is equal to or within five of the direction directed by the value of the “Post card”, or determined by the player if given the choice, the player and all “Good” side bettors win (173) and is paid even money on their wagers unless the card exactly matches the dealer card in which case they are paid at 3 to 2 (183); (14) if the player loses (171 or 172), the “Wide” side bettors are paid at even money (171) unless the card is equal to where the “Referee” marker is (172), in which case if the card was a Spade, Club, or Heart, the “Wide” bettors push (tie) (181), and if it is a Diamond they lose (182); (15) if the player wins (184), he can let his winnings ride, add or subtract to his “Ante” space and request another “Kick” card and returning to step (5) until he loses or passes to the next player; (16) if the player loses at any point of his turn, the dealer is finished with that player and moves to the next player (161); (17) if the player wins three or more “Kicks”, the next player has the option of requesting a new dealer up card to move the “Goalposts” (191), but does not get the automatic Ace of Diamonds win that comes with the initial dealer up card; (18) if all players have had their opportunity to play, a new round commences (1101) at step (1); (19) in a single deck game, the cards are shuffled after each round; (20) in a manual multideck game, if the shoe reaches the cut card, when the round is over the cards are shuffled and play recommences at step (1). (21) in an electromechanical or video gaming system, such as a continuous shuffle multi-deck game, a player's kick cards are removed from the layout and replaced in the machine before the next player.

For example, if the dealer has dealt himself an Ace of Diamonds, all players are automatic winners and are paid at 1 to 1. The dealer then directs his attention to each individual player from his left to right. If the dealer's card was a 6, 7, 8, or 9, or an Ace other than of the Diamonds suit, the player announces to the dealer whether he wants to go “High”, meaning he/she thinks the next card will be equal to or within 5 units of value higher than the dealer's card, or “Low” meaning he/she thinks the next card will be equal to or within 5 units of value lower than the dealer's card. If the dealer's card is less than 6 and not an Ace, the player is automatically considered to go “High”, and if it is more than 9 and not an Ace he is automatically considered to go “Low”. If the dealer is dealt an Ace of either the Spades, Hearts, or Clubs suits, the player can choose whether he wants the value of the Ace to be “Low” meaning the Ace has a value of 1 and his subsequent cards must be between Ace and 6, or “High” meaning the Ace has a value of 14 and his subsequent cards must be between 9 and Ace. The “Goalpost” marker is placed straddling the appropriate marks on the game layout and the “Referee marker is placed one spot beyond the highest “Goalpost” spot unless it is a high Ace, in which the “Referee” is placed on the “8” spot. If the player is dealt an Ace of Diamonds, he/she and all “Good” and “Wide” side bettors are automatic winners and are paid at 1 to 1. If the player's card “fits through the goalposts” of the aforementioned winning card values, he/she and all “Good” side bettors win their wager at 1 to 1 odds, unless the card exactly matches the dealer card in a multideck game, in which the payout is 3 to 2 (1½ to 1). If the player is dealt a card that has the same face value as either spot covered by a Goalpost, and any player wagered on this occurrence, those players are paid at 5 to 1. The player who wins then has the option of continuing by letting his/her winnings ride, adding to or subtracting from their bet, by selecting “High” or “Low” if they have the option, and having another card dealt to them, or they can pass to the next player. If they pass to the next player after a win, all side wagers on a 3 or 6 consecutive win run are returned if they were not given the chance to win without a player loss. A player can keep playing and receiving cards until they lose. If they win three, all side betting on the “3 Run” spot are paid at 5 to 1 (6 to 1 in version 2) unless there is “6 Run” betting in which settlement is delayed until it is determined whether these bets also win. If they win six, all side betting on the “6 Run” spot are paid at 25 to 1 (18 to 1 in version 2). If the previous player won three or more attempts and passes without losing, the new player has the option of requesting a new dealer up card to move the “Goalposts”, but a new dealer card Ace of Diamonds has no automatic win effect. After all players have played their “Kicks” using the dealer's “Post” card, a new round commences from the beginning. If a single deck is used, the cards are shuffled between each round, and if multiple decks are used manually, the rounds continue until the cut card of the shoe is reached, where at the end of that round the multiple decks are shuffled and replaced in the shoe and recut with the cut card. If an electromechanical continuous shuffler is used, cards from each player are replaced into the machine after their turn, and all cards are replaced into the machine before starting a new round.

There is a variation for a multiple deck game where the casino (house) could insert a Joker or other “wild” card into the decks to act as an automatic winner similar to the Ace of Diamonds, as a device to enhance the players' odds and lessen the casino's advantage. The casino can determine at what odds the Joker would pay out to adjust the level of the player advantage/casino disadvantage.

The only influence the dealer exerts in the game is his lone face up card at revelation, and unlike most other casino type games, the dealer is not given an equivalent hand to a player. In other words, the dealer has only one chance in 52 of positively influencing the outcome (in a Jokerless game), although it may be that the game may be modified to change the dealer's chances of either positively or negatively influencing the players.

The suggested odds for the Field Goal game were determined by computer trials of the game as well as the probability of the wagered events occurring as determined by expert gaming statistical analyses.

Although described relative to a particular embodiment with exemplary odds, it will be appreciated that the odds used are suggested odds, and can be adjusted to alter the outcomes discussed in the attached report.

In yet another alternative embodiment, the manner of playing an exemplary game is characterized from the perspective of the dealer, where the specific actions carried out by the dealer are represented in the flowchart of FIGS. 2A-2B, and described in conjunction with the game-board layouts of FIGS. 1A and 1B. As noted previously, the game may be played on a number of surfaces, and the layout is intended to be employed with a conventional blackjack style playing table or surface (e.g., a table of approximately 70-80 inches in length by approximately 40-50 inches in width and having at least one curved edge for players to sit or stand along), although a suitable rectangular-shaped table will suffice as well. Moreover, a card-dealing system may be placed on or adjacent the surface. Initially, the game begins when the player places bets or wagers on the “Ante” space in front of them.

Then, the dealer puts out or deals a first card face up to himself. If his card is the Ace of Diamonds, he pays all players at even money to their “Ante” wagers. Otherwise the dealer then goes to the first player to commence the individual player aspect of the game.

If the dealer's card is a 6, 7, 8, 9, or Ace not of the Diamonds suit, the player exercises his option to go “Low” or “High” to decide which direction from the dealer's “Post” card he wants the “Kick” or next card revealed to fall within. If the dealer's card is any other value, the direction from the “Post” for subsequent player cards or “Kicks” is automatically determined.

Next, the dealer sets the “Goalposts” on the respective layout spots to cover the range of card values selected by either the dealer card alone or in conjunction with the active player's (“Kicker's”) choice of direction. The dealer then places the “Referee” marker one spot higher than the highest Goalpost, unless the high Goalpost is the high Ace, when the “Referee” is then set to the “8” spot on the layout. The other non-active (non “Kicker”) players may then place side wagers on the kick being “Good” or “Wide”, and all players can wager whether the “Kick” will “Hit the Goalpost” or whether the active player will make three “Kicks” in a row or six “Kicks” in a row. The dealer deals a face up card to the player. If the up card is the Ace of Diamonds, the player and all side bettors win automatically and are paid at 1 to 1 odds or even money to his wager. If the up card or “Kick” is equal to the dealer's “Post” card or comes within a value of 5 from the dealer's card in one direction either determined automatically or chosen by the player, the player and “Good” side bettors win and are paid even money. If the “Kick” is the identical card in value and suit to the dealer “Post” card, then the player and any “Good” side bettors are paid at 3 to 2 or one and one half times their wager. If the “Kick” is not good, the “Wide” side bettors win, unless the “Kick” card value is the same as the “Referee's space”. When that happens, and the card is a Spade, Club or Heart, the “Wide” bettors push and have their bet returned. If the card is a Diamond, the “Wide” bettors lose which means the casino wins all player, “Good: and “Wide” bets made. If the “Kick” hit either Goalpost, those side bettors win and are paid at 5 to 1.

If the player wins his “Kick” up card wager, he has the option of leaving all the original wager and winnings on the table, adding to or subtracting from his “Ante” and taking another “Kick” up card from the dealer to continue his win streak, or pass to the next player in the rotation. “Hit the Goalpost” wagering can occur before each dealt “Kick” to a player. If the player wins again he/she can continue to exercise this option until he/she loses. If the player wins three or more “Kicks”, and passes without a loss, the next player has the option of requesting a new dealer up card to move the “Goalposts”, but the dealer Ace of Diamonds automatic win does not apply to any subsequent dealer cards revealed in a round. If the player made three consecutive “Kicks”, those players who wagered on the “3 Win Run” will win at 5 to 1 (6 to 1 in version 2), and if the player made six consecutive “Kicks” those players who wagered on the “6 Win Run” will win at 25 to 1 (18 to 1 in version 2). The dealer then removes any player up cards from the table and if a multideck electromechanical continuous shuffler is used, the cards are replaced into the machine.

The dealer then moves to the next player to repeat the same sequence described above. This is repeated for each player. The dealer then removes his “Post” up card, which constitutes one round. The dealer deals his/herself a new up card “Post”, and begins the process with the players anew. It is optional but not standard that the dealer rotates around the table who the lead off player is to receive up cards or “Kicks” during each round and distinguishing that player with a special marker that is placed in front of the lead off player's station.

Although the disclosed embodiments suggest up to seven players, it will be appreciated that the game layout and table orientation, and the on-line or video-gaming embodiments described above, could facilitate more or fewer players, and the disclosed embodiments are not intended to indicate a particular number of players or limit on the number of players.

It will be further appreciated that while several examples or techniques for placing wagers have been described, there are various alternatives that may be employed to reflect or record the wagers of players or users of systems that implement the disclosed game. For example, in a computer-based implementation, the user's selection (e.g., mouse-click) of a wagering location may result in an auxiliary menu (e.g., drop-down menu) with various wagering amounts for selection or representations of casino chips of various denominations. And, once made, the wagers may be illustrated in various ways using alternative background or foreground colors, shading, etc. It may also be possible to simulate the physical game, by providing a movable “chip” that can be placed or dragged/dropped on a wagering location. The details of such wagering techniques are not disclosed herein as they are believed to be known relative to other on-line and portable or hand-held casino gaming technologies.

Other alternatives and modifications to the operations and methods disclosed above may include the ability of each player to be dealt an initial card face up, to replace the dealer card, for determining different ranges of winning so that subsequent cards can be substituted without altering the outcomes discussed above. Or, the option for each player to vocally choose his initial card face to replace the dealer card for determining different ranges of winning, and subsequent cards can be substituted without altering the outcomes discussed above.

Moreover, as previously noted, the disclosed methods may employ alternative sport themes such that the sport can be changed to represent any other sport without altering the outcomes discussed above. Of course, the playing card suits and/or values selected for special treatment during the game are suggested and can be substituted without altering the outcomes discussed above.

It should be understood that various changes and modifications to the embodiments described herein will be apparent to those skilled in the art. Such changes and modifications can be made without departing from the spirit and scope of the present disclosure and without diminishing its intended advantages. It is therefore anticipated that all such changes and modifications be covered by the instant application.

What is claimed is:

1. A method of playing a sport-themed casino game, comprising:
(a) providing a “deck” or multiple “decks” (physical or virtual) of playing cards;
(b) providing a wagering and card play area in which wagers may be placed by participants in a Black Jack-type fashion, wherein the area includes individual player stations in order for the player to make the wagers of the game as well as an area to receive cards from the dealer;
(c) a dealer area to receive the dealer up card;
(d) another semicircular area with spots labeled “A”, “2”, “3”, “4”, “5”, “6”, “7”, “8”, “9”, “10”, “J”, “Q”, “K”, and “A”, for the dealer to mark the “Goalposts” of the 6 (six) consecutive card values players must hit with their dealt cards, and a “Referee” marker to provide a house advantage for “Wide” side bettors;
(e) the game being played by the following steps:
(1) players make wagers placed on the wagering spaces in front of them at their individual station;
(2) the dealer distributing an up card to himself;
(3) the dealer paying even money for a win automatically if his card is Ace of a pre-designated suit;
(4) The dealer asking players if they wish to go “High” or “Low” during their turn if the dealer up card is a 6, 7, 8, 9, or Ace of a suit other than the pre-designated suit;
(5) The dealer marks the spots on the game layout with the “Goalposts” and the “Referee” marker;
(6) Non-active players may side bet on whether or not the active player will be successful or unsuccessful after he/she receives their card from the dealer;
(7) All players engaging in possible side wagering that any card dealt to a player will have the same face value as the spots directly covered by either Goalposts, or that a player will have a three or six consecutive win run;
(8) the dealer distributing a face up card to each player one player at a time;
(9) the dealer settling the active player's wager as well as all “Good” side bettors by removing losing wagers and paying those players and side bettors who were dealt a card the same as one of the six consecutive covered face values with Aces equal to 1 or 14, Jacks=11, Queens=12, and Kings=13, as well as all “Wide” side bettors;
(10) the dealer then giving the winning player the right to continue playing by adjust his “Ante”, having new side bets wagered on him/her and asking for another card from the dealer;
(11) the dealer then giving the winning player the right to continue playing until he/she loses or passes to the next player;
(12) if a player wins three or more consecutive times during his turn, the next player has the option of having the dealer deal himself a new up card to switch the winning subsequent player cards, but players at the table do not receive the dealer Ace of pre-designated suit automatic win for this second or further dealer cards during a round;
(13) all multiple-win run side wagers are settled;
(14) the dealer clearing that player's cards from the table and moving to the next player and returning to step (4)
(15) if all players have been given a turn, the dealer removes his card and the round ends

2. The method according to claim 1, where subsequent rounds are completed by repeating steps beginning at (e).

3. The method according to claim 1 wherein another card is selected as the “wild” card to replace the Ace of the pre-designated suit as an automatic winning card.

4. The method according to claim 1 wherein the game is adapted to represent any sport and the goalposts are employed to represent a goal or similar element of such a sport.

5. A game board comprising a wagering area for each of a plurality of individual player stations, in which a wager may be placed by a participant in a blackjack-type fashion, wherein said wagering area includes:
(1) an area for wagering that the player will receive a minimum of one card of the face value being equal to or within N consecutive numbers away from the dealer's up card, where N is greater than 2 and less than 8.
(2) areas associated with each player's position about the game board, for side wagering that the player will or will not receive a card of the face value being equal to or within N consecutive numbers away from a dealer's up card;
(3) wherein the same area may be employed to allow the player to continue a win streak by receiving extra face up cards;
(4) areas, also adjacent each player position, for side wagering: (i) that any card dealt to an active player will have the same face value as a spot covered by a goalpost,
(ii) that the active player will win three times in a row without a loss, and
(iii) that the active player will win six times in a row without a loss.
(5) linear and concentric semicircular areas in front of a dealer position to mark possible winning cards and explaining payouts for dealt cards.

6. The casino game board according to claim 5, further comprising a face up card area for a dealer's card.

7. The casino game board according to claim 5, wherein the game board is presented on the surface of a table.

8. The casino game board according to claim 5, wherein the game board is presented on an electronic display as an electronic game.

9. The casino game board according to claim 8, wherein the game board is presented as part of a portable electronic game on a mobile device.

10. The casino game board according to claim 8, wherein the board is presented as part of a game played over internet network with remotely-located players.

11. A method of conducting a wagering game on a video gaming system including a processor, a video display and player input controls, comprising:
(a) a processor acting as a dealer providing at least one virtual deck of playing cards;
(b) providing a wagering and card play area in which Black Jack-type wagers may be placed by participants, wherein the wagering and card play area includes individual player stations in order for a player to make the wagers of the game as well as an area to receive cards from the dealer;
(c) a dealer area to receive a dealer up card;
(d) a semicircular area with spots labeled “A”, “2”, “3”, “4”, “5”, “6”, “7”, “8”, “9”, “10”, “J”, “Q”, “K”, and “A”, for the dealer to mark at least two “Goalposts” to indicate a range of consecutive card values players must hit with their dealt cards, and a “Referee” marker to provide a house advantage for “Wide” side bettors;
(e) the game being played by the following steps:
(1) at least one player makes a wager by indicating the wager on a wagering space in the player's station;
(2) the processor, acting as the dealer, distributing an up card, the dealer up card indicated in the dealer's station;
(3) the processor, acting as the dealer, examining the respective dealer and player's hands and paying even money for a win automatically if the player's card is a pre-designated card;
(4) the processor otherwise requesting input from players to determine if they wish to go “High” or “Low” during their turn if the dealer up card is a 6, 7, 8, 9, or Ace of a suit other than Diamonds;
(5) the processor, acting as the dealer, marks card face values on the game layout with the “Goalposts” and the “Referee” marker, wherein the Goalposts identify the range of cards;
(6) the processor allowing non-active players to place a side wager on whether or not the active player will be successful or unsuccessful after the active player receives another card from the dealer;
(7) the processor further allowing for a player to engage in a possible side wager that at least one of the following will occur
(i) any card dealt to a player will have the same face value as the card face values covered by a Goalpost, or
(ii) that a player will have a three or six consecutive win run;
(8) the processor, acting as the dealer, distributing a face up card to each player, one player at a time;
(9) the processor, acting as the dealer, settling an active player's wager as well as all “Good” side bettors by removing losing wagers and paying those players and side bettors that were dealt a card the same as one of the six consecutive covered face values with Aces equal to 1 or 14, Jacks=11, Queens=12, and Kings=13, as well as all “Wide” side bettors;
(10) the processor, acting as the dealer, then giving a winning player the right to continue playing by adjusting the winning player's “Ante”, having new side bets wagered on him/her and requesting another card from the dealer;
(11) the processor, acting as the dealer, then giving the winning player the option to continue playing until losing or passing play to a next player;
(12) should a player win three or more consecutive times during a turn, the next player has the option of having the processor, acting as the dealer, deal a new up card to switch the winning subsequent player cards, provided that players do not receive the dealer pre-designated card automatic win for those or any subsequent dealer cards during a round;
(13) the processor resolving any side wagers;
(14) the processor, acting as the dealer, clearing that player's cards from the virtual table display, moving to the next player and returning to step (4); and
(15) when all players have been given a turn, the processor, acting as the dealer, removes the dealer's card and the round ends.

12. The method according to claim 11, wherein the processor, acting as the dealer, sets the Goalposts on respective layout spots to cover the range of card values selected based upon (i) the dealer card alone, or (ii) the dealer card in conjunction with the active player's choice of direction.

13. The method according to claim 12, wherein the Referee marker is placed by the processor, acting as the dealer, at one spot higher than the highest Goalpost, unless the high Goalpost is the high Ace, in which case the Referee marker is then set to the “8” spot on the layout.

14. The method according to claim 11, wherein said side wagers include a side wager selected from the group consisting of a “3 Win Run,” and a “6 Win Run”.

15. The method according to claim 13, further including the processor, acting as the dealer, allowing for at least one side wager selected from the group consisting of: (i) a wager that the next card revealed by the dealer to the active player will have the same value as a Goalpost covered spot, referred to as “Hit the Goalpost”; (ii) a wager that the active player will be successful on consecutive attempts by receiving a card falling within the range identified by the goalposts; and (iii) a wager that the active player will receive a card falling outside the range identified by the goalposts.
